(19) United States
(12) Patent Application Publication
(10) Pub. No.: US 2018/0115556 A1
(43) Pub. Date: Apr. 26, 2018

(54) Systems and Methods of Restricting File Access

(71) Applicant: American Megatrends, Inc., Norcross, GA (US)

(72) Inventor: Terry Yukio Otsubo, Duluth, GA (US)

(73) Assignee: American Megatrends, Inc., Norcross, GA (US)

(21) Appl. No.: 15/491,829

(22) Filed: Apr. 19, 2017

Related U.S. Application Data
(63) Continuation-in-part of application No. 15/333,760, filed on Oct. 25, 2016.

(51) Int. Cl. H04L 29/06; G06F 21/62; H04L 29/08

(52) U.S. Cl. CPC H04L 63/108; H04L 63/102; G06F 21/6209; G06F 2221/2137; H04L 67/06; H04L 2463/121; H04L 67/02

(57) ABSTRACT

Example embodiments of the system and methods disclosed herein include receiving a request of a file from a guest of a website, determining that it is access restricted, and securing it to that specific web guest via a folder that expires after a predetermined amount of time, for example, twenty-four hours. A time stamp may be set for the file for the web guest upon receiving the request. Additionally, access may be restricted from free email domains and from import restricted countries.

### CROSS-REFERENCE TO RELATED APPLICATION

This application is a continuation in part of U.S. patent application Ser. No. 15/333,760, filed on Oct. 25, 2016, which is incorporated by reference herein.

### TECHNICAL FIELD

The present disclosure is generally related to computers and, more particularly, is related to file management software.

### BACKGROUND

Typically, a user downloads a file by clicking on a hyperlink on a website. This can be challenging because the user has to find the hyperlink of the file at the website, especially if the website has many sites and/or content and if the website changes frequently.

Because files are securable objects, access to them is regulated by the access-control model that governs access to all other securable objects in an operating system, for example, Windows. A security descriptor can be specified for a file or directory when a function such as CreateFile, CreateDirectory, or CreateDirectoryEx function is called. If NULL is specified for the IpSecurityAttributes parameter, the file or directory may receive a default security descriptor. The access control lists (ACL) in the default security descriptor for a file or directory may be inherited from its parent directory. Note that a default security descriptor may be assigned only when a file or directory is newly created, and not when it is renamed or moved.

To retrieve the security descriptor of a file or directory object, a GetNamedSecurityInfo or GetSecurityInfo function may be called. To change the security descriptor of a file or directory object, the SetNamedSecurityInfo or SetSecurityInfo function may be called.

The valid access rights for files and directories may include the DELETE, READ_CONTROL, WRITE_DAC, WRITE_OWNER, and SYNCHRONIZE standard access rights. The table in File Access Rights Constants lists the access rights that are specific to files and directories.

Although the SYNCHRONIZE access right may be defined within the standard access rights list as the right to specify a file handle in one of the wait functions, when using asynchronous file I/O operations the event handle contained in a properly configured OVERLAPPED structure should be determined first rather than using the file handle with the SYNCHRONIZE access right for synchronization.

The following are the example generic access rights for files and directories:

FILE_GENERIC_EXECUTE

### FILE_EXECUTE

FILE_READ_ATTRIBUTES
STANDARD_RIGHTS_EXECUTE

### SYNCHRONIZE

FILE_GENERIC_READ
FILE_READ_ATTRIBUTES
FILE_READ_DATA
FILE_READ_EA
STANDARD_RIGHTS_READ

### SYNCHRONIZE

FILE_GENERIC_WRITE
FILE_APPEND_DATA
FILE_WRITE_ATTRIBUTES
FILE_WRITE_DATA
FILE_WRITE_EA
STANDARD_RIGHTS_WRITE

### SYNCHRONIZE

The operating system may compare the requested access rights and the information in the thread's access token with the information in the file or directory object's security descriptor. If the comparison does not prohibit all of the requested access rights from being granted, a handle to the object is returned to the thread and the access rights are granted.

By default, authorization for access to a file or directory may be controlled strictly by the ACLs in the security descriptor associated with that file or directory. In particular, the security descriptor of a parent directory may not be used to control access to any child file or directory. The FILE_TRAVERSE access right may be enforced by removing the BYPASS_TRAVERSE_CHECKING privilege from users. This is not recommended in the general case, as some programs may not correctly handle directory traversal errors. A typical use for the FILE_TRAVERSE access right on directories is to enable conformance to certain IEEE and ISO POSIX standards when interoperability with Unix systems is a requirement.

Another means of managing access to storage objects is encryption. The implementation of file system encryption in an example operating system is the Encrypted File System, or EFS. EFS encrypts only files and not directories. The advantage of encryption is that it provides additional protection to files that is applied on the media and not through the file system and the standard operating system access control architecture.

A challenge in web development projects is access restriction to a file uploaded to the internet or on a website. There are heretofore unaddressed needs with previous access restriction solutions.

### SUMMARY

Example embodiments of the present disclosure provide methods of restricted file access. Briefly described, one example embodiment of the method, among others, can be implemented as follows: receiving a request from a web guest to access a file stored on a server; determining that the file is access restricted; setting a time stamp for the file request for the web guest; allowing access for the file by the web guest for a predetermined time from the time stamp; and restricting access for the file by the web guest after the predetermined time from the time stamp.

An alternative embodiment of the present disclosure can also be viewed as providing methods for restricted file access. In this regard, one embodiment of such a method, among others, can be broadly summarized by the following steps: receiving a request from a user to access a file stored on a server; recording an IP address for the user and recording the file requested; creating a hash code of the folder name and folder location of the requested file; sending a file address to the user, the file address including the hash code; setting a time stamp for the request of the file; and deactivating the file address after a predetermined time from the time stamp.

Another alternative embodiment of the present disclosure can also be viewed as providing methods for restricted file access. In this regard, one embodiment of such a method, among others, can be broadly summarized by the following steps: receiving a request from a user to access a file stored on a server; requesting identification of the user; receiving the identification; and restricting access to a user with the received identification

### BRIEF DESCRIPTION OF THE DRAWINGS

FIG. 1 is a system view of a file download system in accordance with an example embodiment of the disclosure;

FIG. 2 is a block diagram that illustrates electrical components in a generic computing device in accordance with an example embodiment of the disclosure;

FIG. 3 is a block diagram of a server having a file download module in accordance with an example embodiment of the disclosure;

FIG. 4 is a flowchart for downloading a file in a server through a web browser over the Internet in accordance with an example embodiment of the disclosure;

FIG. 5 is a form-fill layout that can be utilized by a file download module in accordance with an example embodiment of the disclosure;

FIG. 6 is a web browser screen for submitting a file query for download through a URL entry in accordance with an example embodiment of the disclosure; and

FIG. 7 is a web browser screen for submitting a file query for download through a URL entry on an alternate website in accordance with an example embodiment of the disclosure.

FIG. 8 is a flow diagram of an example embodiment of a method of restricting file access.

FIG. 9 is a flow diagram of an alternative example embodiment of a method of restricting file access.

FIG. 10 is a flow diagram of an alternative example embodiment of a method of restricting file access.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods disclosed herein allow downloads to occur from any URL path in the domain. When a web guest (or user) accesses a website, the application layer reads the URL entered by the web guest. Based on the URL, the application layer checks for a URL string. If a URL string is found, the application layer determines if the URL string contains a file designation. If a file designation is found within the URL string, the application layer processes the request, which may include one or more of the following functions: verifies file, verifies type, determines access rights, determines storage location, determines requirements, allows download, restricts download, displays error message, and logs transaction.

In an example embodiment of a method for downloading a file, a user clicks a link to initiate a download from their Internet browser. This initiates an HTTP GET request to the website. An application checks if the URL contains a query string. If so, it checks if the query string contains a file name. If the query string contains a file name, the application queries the file database for a file with the name in the query string. If the file is found in the file database, the application checks the access level of the file. If the access level is PUBLIC, then the user is able to download the requested file. If the access level is SPECIAL, the user is sent to a download request form. If the access level is REGISTERED, the user is prompted to log in first (or if logged in already) and is ten able to immediately download the requested file. If the access level is NDA or INTERNAL, then the user is prompted that the file does not exist and is sent to the homepage or resources page of the website.

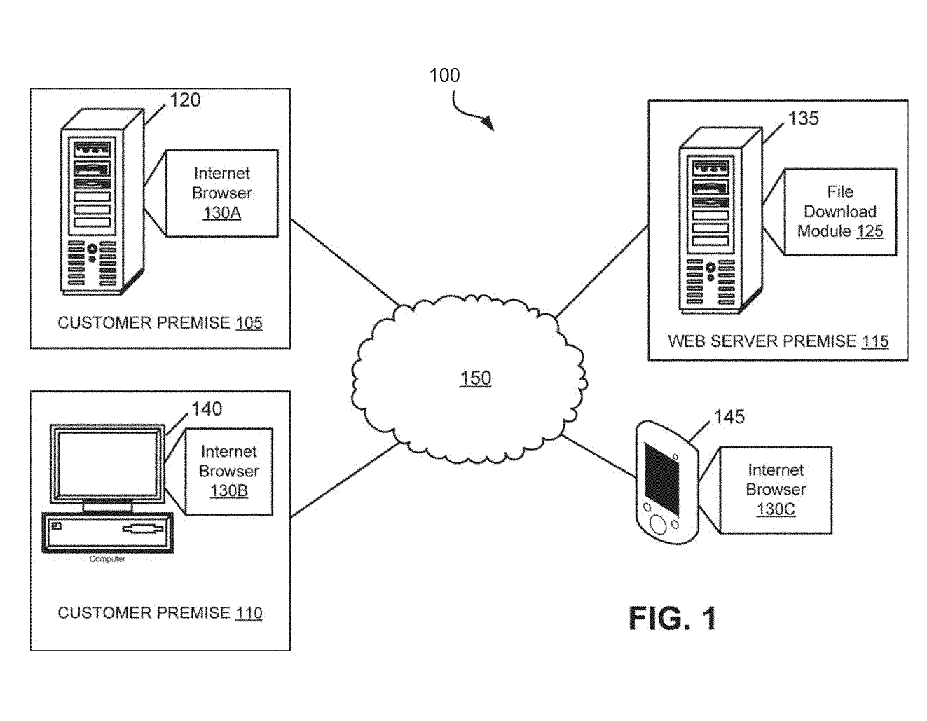

Referring to FIG. 1, file downloading system 100 generally includes at least one customer premise 105 that may include server 120 that runs internet browser 130A, at least one customer premise 110 that runs internet browser 130B on computer 140, at least one web server 115 that runs file download module 125 on, for example, server 135, and portable devices 145 that run internet browser 130C, that can all connect to the Internet. The premises 105, 110, server 115 and the portable devices 145 may be connected to network 150, such as the Internet, telephone network system, and cellular network system.

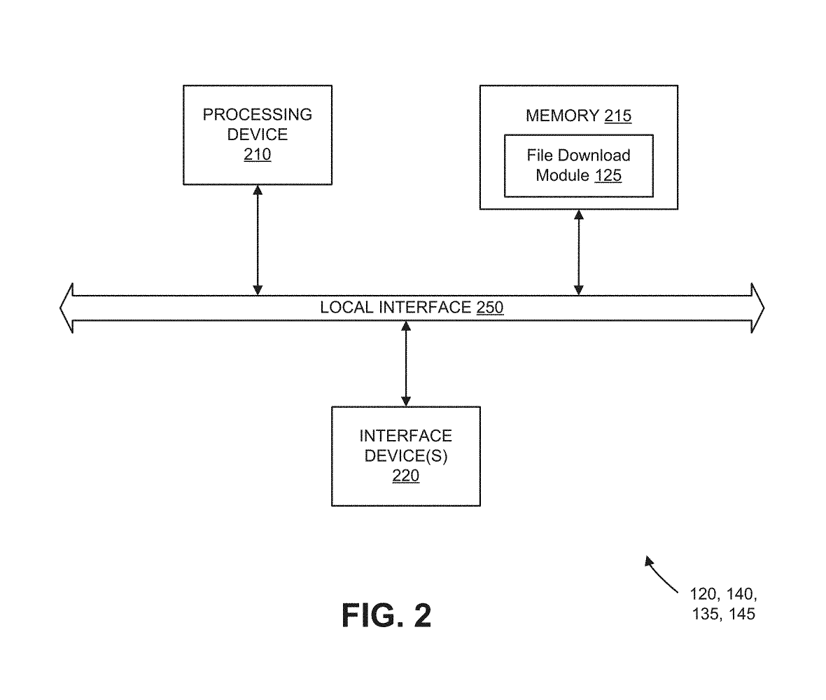

FIG. 2 is a block diagram that illustrates electrical components in a generic computing device in accordance with an embodiment of the disclosure. Any of server 120, computer 140, web server 135, and portable device 145 may comprise processing device 210, memory 215, in which file download module 125 is stored, and one or more interface devices 220 that are connected to local interface 250 such that processing device 210, memory 215 and interface device 220 may interface with each other.

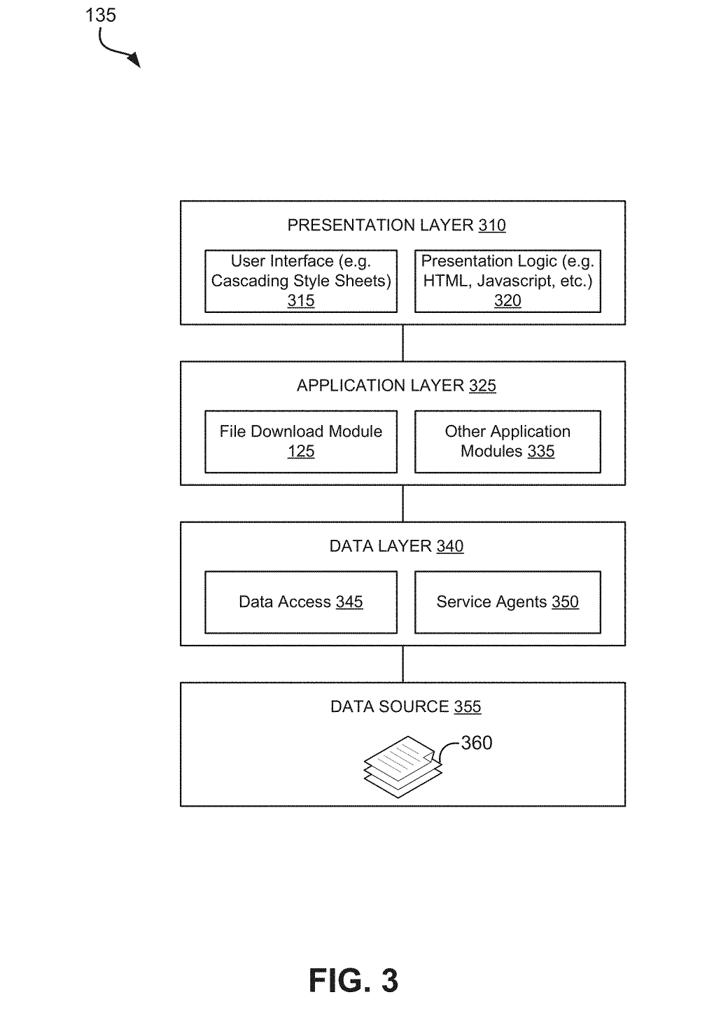

FIG. 3 is a block diagram of a server having a file download module in accordance with an example embodiment of the disclosure. In an example embodiment, web server 135 comprises presentation layer 310, application layer 325, data layer 340, and data source 355. Presentation layer 310 comprises User interface 315 and presentation logic 320. User interface 315 configures the style of the user interface such as in cascading style sheets, as a non-limiting example. Presentation logic 320 comprises the language used to present the user interface, such as HTML and Javascript as non-limiting examples. Application layer 325 comprises file download module 325 and other application modules 335 such as, for example, user management module, page management module, event log viewer module, domain filter module, and reports module, among others. Data layer 340 comprises data access module 345 and service agents 350. Data source 355 comprises the source of data 360.

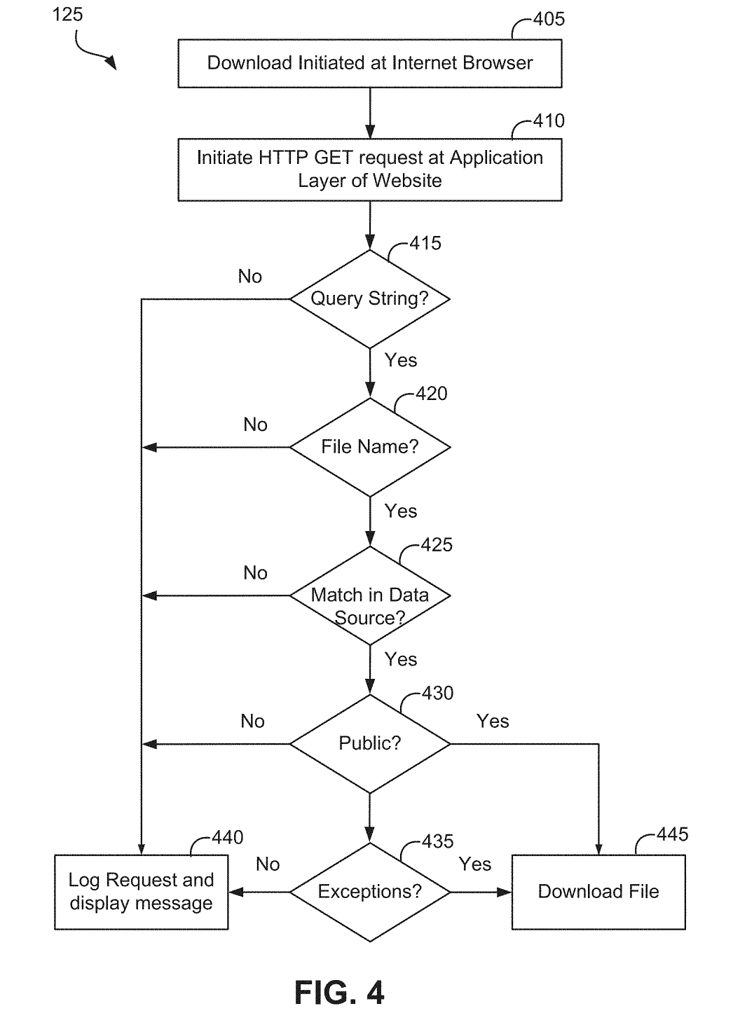

FIG. 4 is a flowchart for downloading a file in a server through a web browser over the Internet in accordance with an example embodiment of the disclosure. In block 405, a download is initiated through an internet browser. In block 410, an HTTP GET request is initiated at the application layer of the website. In block 415, a determination is made as to whether the request contains a query string. If it does not, the process moves to block 440 where the request is logged and a message is displayed. If the request does contain a query string, then the process moves to block 420 in which a determination is made as to whether the query string contains a file name. If it does not contain a file name, the process moves to block 440 where the request is logged and a message is displayed.

If the query string does contain a file name, the process moves to block 425 in which a determination is made as to whether the file name matches a file contained in the data source. If the file name does not match a file in the data source, then the process moves to block 440 where the request is logged and a message is displayed. If the file name does match a file in the data source, then the process moves to block 430 in which a determination is made as to whether the file name is accessible by the public. If the file is not designated as accessible by the public, then the process moves to block 440 where the request is logged and a message is displayed. If the file is determined to be accessible by the public, then, in block 445, the file is downloaded. In block 435, a determination is made as to whether there may be an exception that would allow for the user to download the file even though the file is not accessible by the public. If there are no exceptions, then, in block 440, the request is logged and a message is displayed. If a valid exception exists, then, in block 445, the file is downloaded.

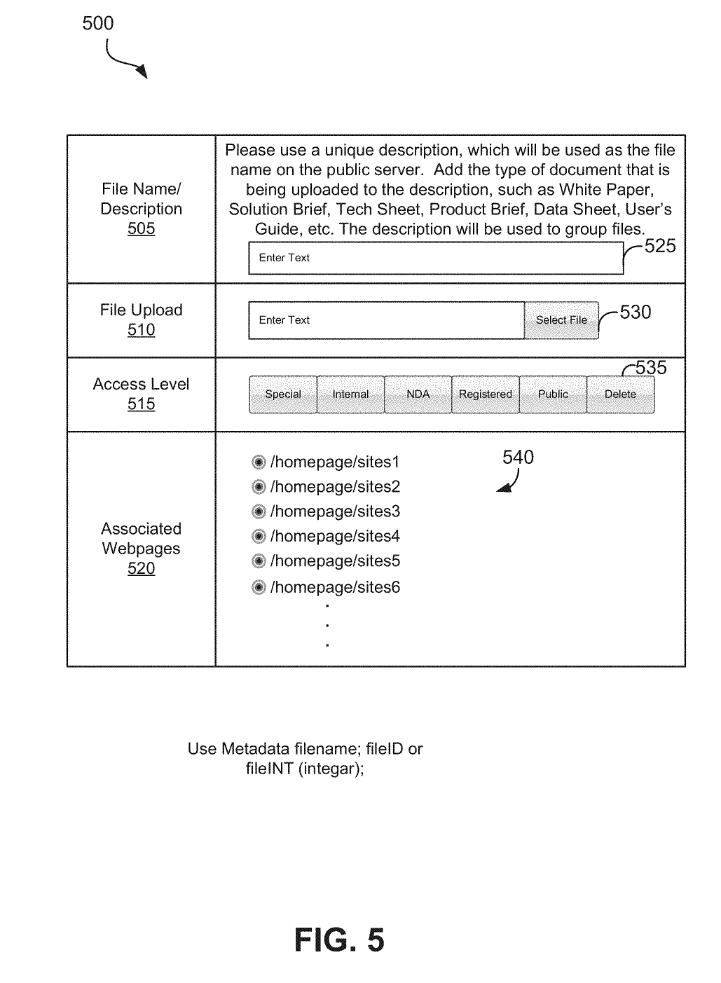

FIG. 5 provides form-fill layout 500 that may be utilized to set up a file that may be downloaded by a file download module in accordance with an example embodiment of the disclosure. In an example embodiment, form-fill layout 500 comprises file name/description field 505, file upload field 510, access level field 515, and associated webpages 520. File name description field 505 is used to enter a unique description of the file, which may be used as the file name on a server. The description may comprise the type of document that is being uploaded, such as White Paper, Solution Brief, Tech Sheet, Product Brief, Data Sheet, and User's Guide as non-limiting examples. In an example embodiment, the description is used to group files.

File upload field 510 may comprise the actual file name, and the “select File” button may be selectable to Browse a file directory to choose the file by file name. When a particular file is chosen, the file name for that file may be populated into file upload field 510. Access level field 515 may comprise one or more selectable buttons for setting the access level of the selected file. Button selections may include “Special,” “Internal,” “NDA,” “Registered,” “Public,” and “Delete,” as non-limiting examples. The delete selection may proscribe a special function for deleting the file from data source 355 of FIG. 3. Associated webpages field 520 may include additional URLs that are related to the file.

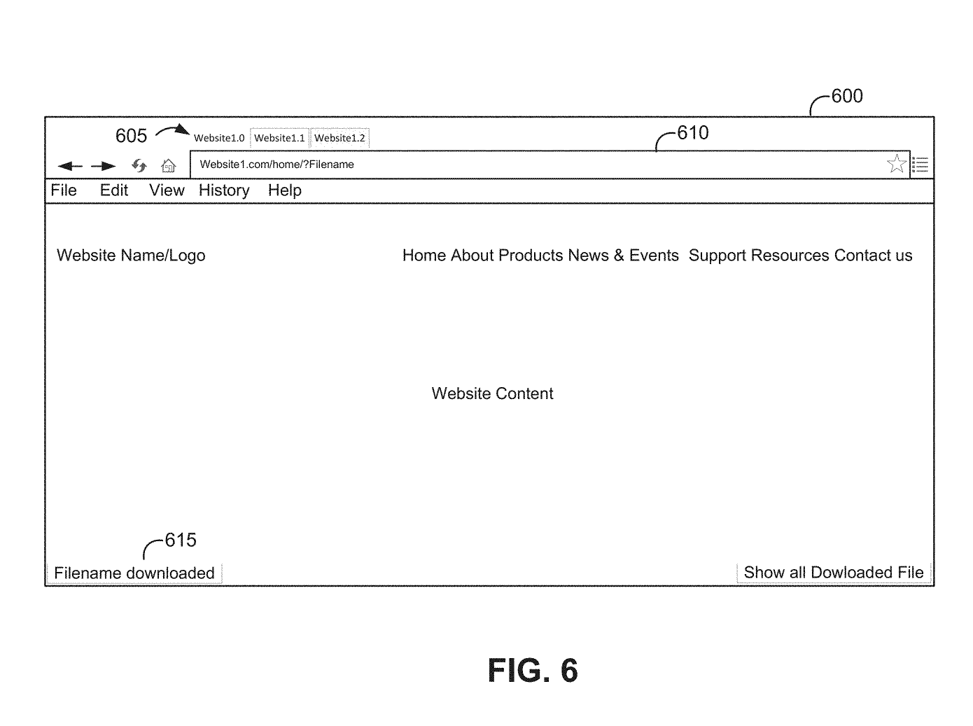

FIG. 6 provides web browser screen 600 for submitting a file query for download through a URL entry in accordance with an example embodiment of the disclosure. Website field 605 comprises the website that is being used to submit the query for the file download. URL field 610 comprises the field into which the query for the file download is entered. Once the query is entered and a file download is completed, File downloaded field 615 provides an indication that the requested file has been downloaded.

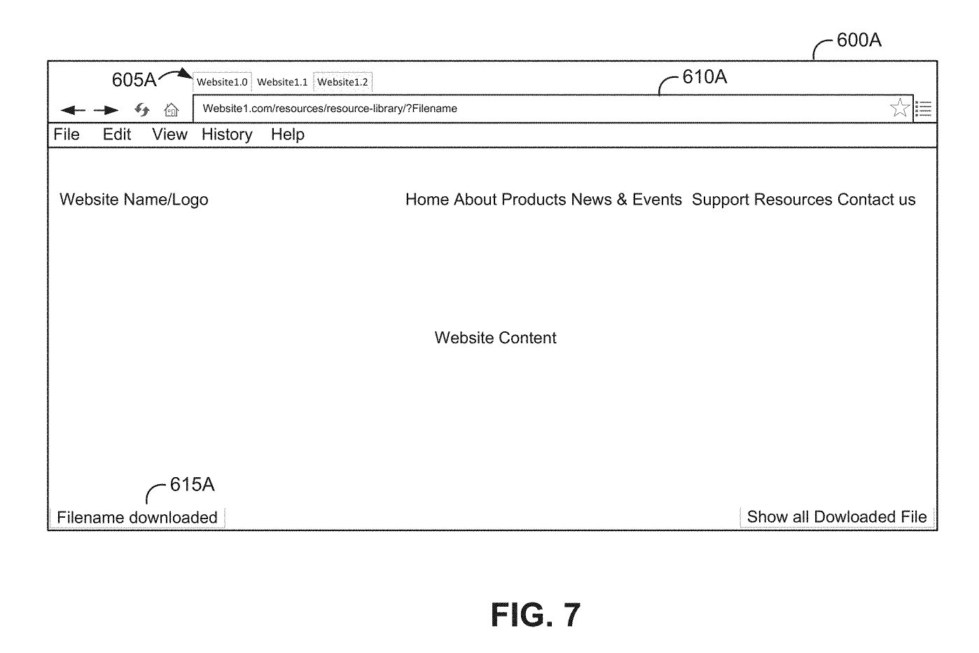

FIG. 7 provides web browser screen 600A for submitting a file query for download through a URL on an alternate website entry in accordance with an example embodiment of the disclosure. Website field 605A comprises the website that is being used to submit the query for the file download. A query may be performed through the same query/database despite being on a different website. URL field 610A comprises the field into which the query for the file download is entered. Once the query is entered and a file download is completed, File downloaded field 615A provides an indication that the requested file has been downloaded.

A further challenge in web development projects is access restriction to a file uploaded to the internet or on a website. A user wants to be able to access a file without knowing the physical location of the file. It is like going into a grocery store for eggs in which the customer can walk in and, no matter what shelf or aisle she goes to, her eggs would be there (if she has the proper access rights to them). As an example, this file may be referred to as “file_restricted_to_a_specific_user.pdf”. If this file is uploaded and that URL or file location is accessible, for instance at http://website.com/filerestrictedto.pdf, the pdf file may be downloaded even if no previous knowledge of the file existed. If a file is available on a website, usually anyone can download it. That user may share that URL with someone else and that person may download that file. In some situations, it may be desirable to restrict access to some files, and the user may not know the exact location of the file.

One present solution generates a folder accessible through a website and saves the file into that folder on the website. For example, instead of saving the web accessible file to website.com/filename.pdf, the file is saved to website.com/restrictedfolders/filename.pdf. If a user doesn't know the folder beyond the domain name, then that user cannot download the file. However, if someone shares that location, then the user would still be able to download that file.

Another present solution for restricting the file uses active directories. With active directories, a user logs in on a network. This user has access rights on the network or the active directory server and on the specific folder. Only the allowed users can access that folder. However; the user has to log in to be able to access the folder. A web-guest shouldn't need to log in; the system should automatically recognize the user. This active directory solution is effective, but requires the user to be granted access rights and to remember a user name and password.

Example embodiments of the system and methods disclosed herein include receiving a request of a file from a guest of a website, determining that the file is access restricted, and securing the file to that specific web guest via a folder that expires after a predetermined amount of time, for example, twenty-four hours. A time stamp may be set for the file for the web guest upon receiving the request. Additionally, access may be restricted from free email domains such as google.com, gmail.com, yahoo.com, among others. Access may also be restricted from import restricted countries. Export restricted countries are listed on the US state department website and change frequently. Current countries listed are: Burma, Côte d'Ivoire, Cuba, Iran, North Korea, and Syria.

According to example embodiments of the systems and methods disclosed herein, when a user requests a file, the request of that user is logged into a database. In an example embodiment, the IP address for that person and the file requested by the user is recorded. A hash code of the folder location and the folder name for the file may be created. The user may receive an address for the file location and the address may include the hash code. When the user enters the address (or clicks on a link for the address), the user download the file without logging in to a network or an active directory server. Only the file location is necessary to download the file. If the user shares that file with another user or shares the location with someone who does not have access to the file, that person who requests the download may be recorded. The other user may still access the file, but the file request is recorded. In an example embodiment, the link becomes inactive after a predetermined time period (such as 24 hours) and the user can no longer access the file.

In an example embodiment of the systems and methods of restricting file access disclosed herein, a code and a data source are used to secure the file from unwanted access. The code may be also called an application and it is the first routine that a website server runs. If a user requests to download a file, the application checks that file against the database to see if that file is access restricted. If it is access restricted, the application determines if the folder and file location exist. If the folder location and file exist, the application records the request and allows access to the file for download. The application may also check the timestamp on the folder when the file request occurs. If the request is within the predetermined time frame, the application grants access to the user to download the file. If the request is not within the predetermined time frame, the application may send a message to the user notifying the user that the file is download restricted. This prevents search bots such as google bot, facebook bot. yahoo bot, and other search engines from mining the file location.

In an alternative embodiment, when a file request is received, the application requests an email address for the user and the file is only accessible for download by that user. In yet another alternative embodiment, the IP address of the user is recorded and the file is only accessible for download by the computer at that IP address

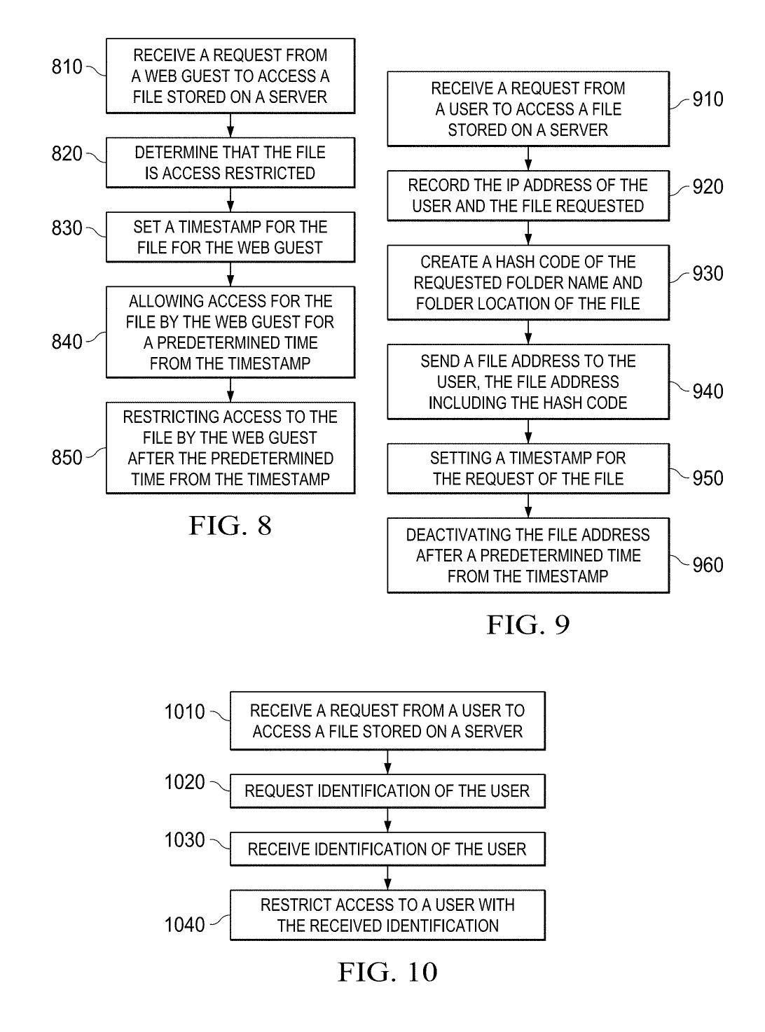

FIG. 8 provides a flow diagram of an example embodiment of a method of restricting file access. In block 810, a request is received from a web guest to access a file stored on a server. In block 820, the file is determined to be access restricted. In block 830, a time stamp is set for the file request for the web guest. In block 840 access for the file by the web guest is allowed for a predetermined time from the time stamp. In block 850, access to the file by the web guest is restricted after the predetermined time from the time stamp.

FIG. 9 provides a flow diagram of an example embodiment of a method of restricting file access. In block 910, a request is received from a user to access a file stored on a server. In block 920, the IP address of the user and the file requested. In block 930, a hash code of the requested folder name and folder location of the file is created. In block 940, a file address is sent to the user, the file address including the hash code. In block 950, a time stamp is set for the request of the file. In block 960, the file address is deactivated after a predetermined time from the time stamp.

FIG. 10 provides a flow diagram of an example embodiment of a method of restricting file access. In block 1010, a request is received from a user to access a file stored on a server. In block 1020, identification of the user is requested. In block 1030, identification of the user is received. In block 1040, access to the file is restricted to a user with the received identification.

The flow chart of FIGS. 4, 8, 9, and 10 show the architecture, functionality, and operation of a possible implementation of the file access restriction software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4, 8, 9, and 10. For example, two blocks shown in succession in FIG. 8 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
receiving a request from a web guest to access a file stored on a server;
determining that the file is access restricted;
setting a time stamp for the file request for the web guest;
allowing access for the file by the web guest for a predetermined time from the time stamp; and
restricting access for the file by the web guest after the predetermined time from the time stamp.

2. The method of claim 1, further comprising:
determining that the web guest is using a free email domain; and
restricting access from the web guest of the free email domain.

3. The method of claim 2, wherein the free email domain comprises one of google.com, gmail.com, and yahoo.com.

4. The method of claim 1, further comprising:
determining that the web guest is originating the request from an import restricted country; and
restricting access for the web guest from the import restricted country.

5. The method of claim 1, further comprising:
creating a hash code of the folder name and folder location of the requested file;
sending a file address to the web guest, the file address including the hash code.

6. The method of claim 1, further comprising:
requesting identification of the web guest;
receiving the identification; and
restricting access to a web guest with the received identification

7. The method of claim 6, wherein the identification is an email address.

8. The method of claim 6, wherein the identification is an IP address.

9. A method comprising:
receiving a request from a user to access a file stored on a server;
recording an IP address for the user and recording the file requested;
creating a hash code of the folder name and folder location of the requested file;
sending a file address to the user, the file address including the hash code;
setting a time stamp for the request of the file; and
deactivating the file address after a predetermined time from the time stamp.

10. The method of claim 9, wherein the user is a web guest.

11. The method of claim 10, further comprising:
setting a time stamp for the file request for the web guest;
allowing access for the file by the web guest for a predetermined time from the time stamp; and
restricting access for the file by the web guest after the predetermined time from the time stamp.

12. The method of claim 10, further comprising:
determining that the web guest is using a free email domain; and
restricting access from the web guest of the free email domain.

13. The method of claim 10, further comprising:
determining that the web guest is originating the request from an import restricted country; and
restricting access for the web guest from the import restricted country.

14. A method comprising:
receiving a request from a user to access a file stored on a server;
requesting identification of the user;
receiving the identification; and
restricting access to a user with the received identification.

15. The method of claim 14, wherein the user is a web guest.

16. The method of claim 15, further comprising:
determining that the web guest is using a free email domain; and
restricting access from the web guest of the free email domain.

17. The method of claim 15, further comprising:
determining that the web guest is originating the request from an import restricted country; and
restricting access for the web guest from the import restricted country.

18. The method of claim 14, wherein the identification is an email address.

19. The method of claim 14, wherein the identification is an IP address.

20. The method of claim 14, further comprising:
creating a hash code of the folder name and folder location of the requested file;
sending a file address to the user, the file address including the hash code;
setting a time stamp for the request of the file; and
deactivating the file address after a predetermined time from the time stamp.
